(19) United States
(12) Patent Application Publication
(10) Pub. No.: US 2007/0183595 A1
(43) Pub. Date: Aug. 9, 2007

(54) Wireless entertainment and security system

(75) Inventor: Edward Liu, City of Industry, CA (US)

Correspondence Address: Raymond Y. Chan, 108 N. Ynez Ave., #128, Monterey Park, CA, 91754, US

(73) Assignee: Concept Enterprises, Inc.

(21) Appl. No.: 11/351,703

(22) Filed: Feb. 9, 2006

(51) Int. Cl. H04N 7/167

(52) U.S. Cl. 380/201

(57) ABSTRACT

A wireless entertainment and security system includes a security arrangement, a base station, and a wireless communication arrangement. The security arrangement includes a video activator defining a security area, and a video capturing device electrically linked to the video activator and arranged in such a manner that when the video activator activates the video capturing device, the video capturing device is arranged for capturing video within the security area. The base station includes a display unit, an entertainment module arranged for reading a multi-media data, and a security control module, wherein the display unit is linked to the entertainment module and the security control module for selectively switching between a default entertainment display mode and a security display mode. The wireless communication arrangement wirelessly links the security arrangement with the base station to wirelessly transmit the video data to the security control module when the video capturing device is activated.

### BACKGROUND OF THE PRESENT INVENTION

1. Field of Invention

The present invention relates to a security and an entertainment system, and more particularly to a wireless entertainment and security system which is capable of capturing and displaying video images in specific situations while normally playing multimedia data.

2. Description of Related Arts

A conventional basic security system usually comprises a motion sensor, and an alarm system electrically connected with the motion sensor in such a manner that when the motion sensor detects unusual movement (which may be caused by a potential trespasser) within a specific security area, a warning signal will be generated by the alarm system for alerting the owner of the security area to take further actions against the potential trespasser.

A more sophisticated security system will usually further comprise a surveillance camera mounted in a predetermined position to capture video images from the security area, and a display unit electrically connected with the surveillance camera for displaying the video images so that the relevant personals (such as the owners or security enforcement officials of the security area) to monitor the security condition over the security area through video images.

There are several disadvantages about these conventional security systems. First and foremost, the various components of each of the security systems are electrically connected by wires, some of them are, perhaps for the aesthetic purpose, deeply embedded under the ground or within the walls in domestic buildings. As a result, when replacement or maintenance of one or more of these components (including the wires themselves) is necessary, they can be very difficult to be reached by technicians.

Second, the effective of the above-mentioned security systems varies from one system to another. For the first type of the security system, much would depend upon the warning generated by the alarm system. Since the warning is usually delivered in the form of sound, the extent to which the user is alerted of potential trespasses ultimately depends on whether or not the user hears the warning sound. In the ordinary course of events this should not be a problem. However, when the user is doing some activities which draws much of his attention (e.g. watching a movie with sophisticated sound effect), or the user is in the restroom, he may not be able to hear the warning sound.

For the second type of the security systems, in order to perform security enforcement, the user must arrange someone to monitor the display unit so as to get the latest information of what is going on in the security area. This proves troublesome. The user has either to keep monitoring on the display unit by himself or hire somebody else to perform this task. It seems that in a typical domestic environment, both are practically inconvenient, if not infeasible at all.

For some of these systems, the display unit may be embodied as a television so that the video image over the security area is shown in the television at a particular channel. While this avoids the problem of having an extra display unit (thus perhaps less expensive), but it is inconvenient on the part of user, in that monitoring the security area means the user has to stop watching other television channels.

### SUMMARY OF THE PRESENT INVENTION

A main object of the present invention is to provide an entertainment and security system which is capable of capturing and displaying video images in specific situations while normally playing multimedia data.

Another object of the present invention is to provide an entertainment and security system in which the various components of the system are wirelessly communicated so as to avoid the problems of complicated wiring present in conventional security systems. In other words, it is extremely convenient for the user to replace components and to utilize the present invention in different sites.

Another object of the present invention is to provide an entertainment and security system which allows the user to normally play multimedia data in an entertainment display mode while alerting the user of any suspected movement within a security area by switching the entertainment display mode into a security display mode. In other words, the user has to stop watching the multimedia materials and monitor the situation when suspected movement in the security area is detected. This minimizes the chance of missing a warning sound on the part of the user of the present invention.

Another object of the preset invention is to provide an entertainment and security system which comprises a remote panel which is portable by the user and is adapted to alert the user when suspected motion is detected within security area. In other words, when the user is in the area of a building where conventional alarm signal is difficult to reach, the remote panel is capable of providing warning signal to the user for effective security enforcement.

Another object of the present invention is to provide an entertainment and security system which is capable of incorporating in a doorbell system of a typical domestic building so that the present invention may work operatively with a doorbell system for providing optimal security monitoring to that domestic building.

Another object of the present invention is to provide an entertainment and security system which may be partially operated by solar energy so as to promote environmentally-friendly use of electrical devices.

Accordingly, in order to accomplish the above objects, the present invention provides a wireless entertainment and security system, comprising:

a security arrangement which comprises a video activator defining a security area, and a video capturing device electrically linked to the video activator and arranged in such a manner that when the video activator activates the video capturing device, the video capturing device is arranged for capturing video within the security area and converting the video into a video data;

a base station which comprises a display unit, an entertainment module arranged for reading a multi-media data, and a security control module, wherein the display unit is linked to the entertainment module and the security control module for selectively switching between a default entertainment display mode for displaying the multi-media data and a security display mode for displaying the video data; and

a wireless communication arrangement wirelessly linking the security arrangement with the base station to wirelessly transmit the video data to the security control module such that when the video capturing device is activated, the security display mode is automatically switched on that the security control module starts to receive the video data to be displayed at the display unit.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of a wireless entertainment and security system according to a preferred embodiment of the present invention.

FIG. 2 is a schematic diagram of the doorbell module according to the above preferred embodiment of the present invention.

FIG. 3 is a schematic diagram of the base station according to the above preferred embodiment of the present invention.

FIG. 4 is a schematic diagram of the remote panel according to the above preferred embodiment of the present invention.

### DETAILED DESCRIPTION OF THE PREFERRED EMBODIMENT

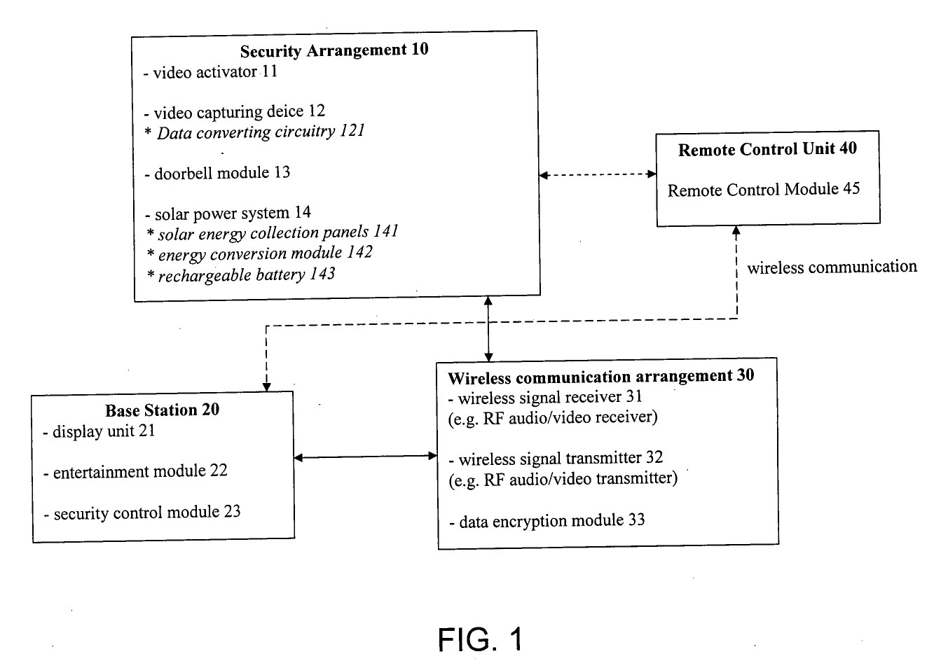

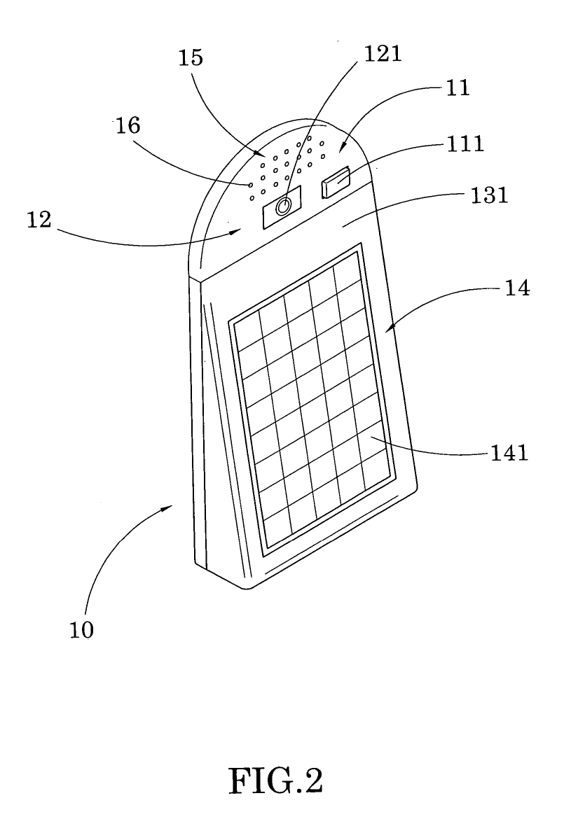

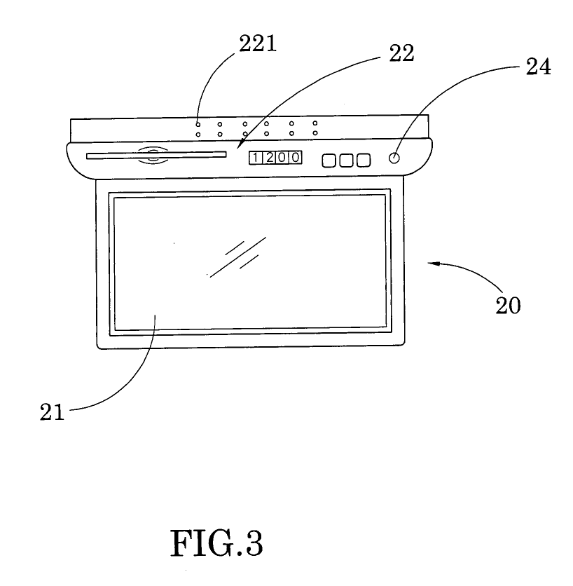

Referring to FIG. 1 to FIG. 4 of the drawings, a wireless entertainment and security system according to a preferred embodiment of the present invention is illustrated, in which the wireless entertainment and security system comprises at least one security arrangement 10, a base station 20, and a wireless communication arrangement 30.

The security arrangement 10 comprises a video activator 11 defining a security area, and a video capturing device 12 electrically linked to the video activator 11 and arranged in such a manner that when the video activator 11 activates the video capturing device 12, the video capturing device 12 is arranged for capturing video within the security area and converting the video into a video data.

The base station 20 comprises a display unit 21, an entertainment module 22 arranged for reading a multi-media data, and a security control module 23, wherein the display unit 21 is linked to the entertainment module 22 and the security control module 23 for selectively switching between a default entertainment display mode for displaying the multi-media data and a security display mode for displaying the video data.

The wireless communication arrangement 30 is wirelessly linking the security arrangement 10 with the base station 20 to wirelessly transmit the video data to the security control module 23 such that when the video capturing device 12 is activated, the security display mode is automatically switched on that the security control module 23 starts to receive the video data to be displayed at the display unit 21.

According to the preferred embodiment of the present invention, the security arrangement 10 further comprises a doorbell module 13 located in the security area wherein the video activator 11 and the video capturing device 12 are operatively communicated with the doorbell module 13 for detecting suspected motion within the security area. More specifically, the doorbell module 13 comprises a weatherproof doorbell housing 131 wherein the video activator 11 and the video capturing device 12 are provided in the doorbell housing 131 in such a manner that when the video activator 11 detects suspected motion within the security area, the video capturing device 12 is activated to capture the video image within the security area so as to capture the suspected motion.

The video activator 11 comprises a doorbell actuator 111 provided on the doorbell module 13 and is adapted to be depressed for actuating a door bell which is electrically extended in the user's domestic building. Moreover, when the video activator 11 is depressed, the video capturing device 12 is activated to capture a video image in the security area. The video capturing device 12 comprises a video camera 121 provided on the doorbell housing 131 at a predetermined position for capturing color video images in the security area in a real-time basis when the video actuator 11 is activated, and a data converting circuitry 122 linked with the video camera to convert the video image from the video camera 121 into the video data.

Alternatively, the doorbell video actuator 11 may comprise an infrared sensor provided on the doorbell module 13 for detecting any suspected motion in the security area, wherein when a suspected motion is detected, the video capturing device 12 is activated to capture video image in the security area.

The security arrangement 10 further comprises a solar power system 14 mounted on the doorbell module 13 for collecting solar energy as a power supply for the security arrangement 10, and comprises a plurality of solar energy collection panels 141, an energy conversion module 142 electrically connected with the solar energy collection panels 141, and a rechargeable battery 143 electrically connected with the energy conversion module 142 in such a manner that the solar energy collection panels 141 are adapted to absorb solar energy which is converted into electrical energy in the energy conversion module 142. The electrical energy thus converted is then stored in the rechargeable battery 143 for further use. According to the preferred embodiment of the present invention, the security arrangement 10 is operated by solar energy so that the rechargeable battery 143 is electrically connected with the video capturing device 12 for acquiring electrical power to capture video image within the security area.

The security arrangement 10 further comprises a first audio unit 15 comprising a stereo microphone and a stereo speaker 16 provided on the doorbell module 13 for receiving and delivering audio signal from and to a potential guest or trespasser respectively. The first audio unit 15 is preferably embodied as a stereo microphone which allows the potential guest or the trespasser to transmit audio signal to the user (e.g. request for door opening). The stereo speaker 16 is embodied as a regular stereo speaker which is capable of generating sound spoken by the user of the present invention. As a result, the user and the potential trespass or the guest are able to speak with each other via the first audio unit 15 and the stereo speaker 16. Moreover, both the first audio unit 15 and the stereo speaker 16 are operated by the solar power system 14.

Thus, it is worth mentioning that an alternative energy source may be utilized in lieu of or in supplementary to the solar power system 14 so as to enhance an operational stability of the security arrangement 10.

The base station 20 is preferably located in the user's residential or commercial building to which the wireless entertainment and security system gives protection. The display unit 21 comprises a LCD display panel (e.g. 10.2″ widescreen LCD) which is arranged to selectively display both the multimedia data read from the entertainment module 22 and the video image captured by the video capturing device 12. On the other hand, the entertainment module 22 comprises a multimedia player, such as a DVD player or a VCD player, adapted to read a corresponding type of multimedia data for playing a VCD or a DVD, wherein the video image of the VCD or the DVD is displayed on the display unit 21. In order to enhance the range of applications of the base station 20, the entertainment module 22 may further comprise a radio unit and a television tuner unit for processing radio signal and television broadcast signal which is to be displayed on the display unit 21. Therefore, the entertainment module 22 further comprises a second audio unit 221 comprising a stereo microphone and a stereo speaker provided on the base station 20 for recording and delivering multimedia audio signal respectively.

In other words, the first audio unit 15 is communicatively provided at the security arrangement 10 and the second audio unit 221 is communicatively provided at the base station 20 and is wirelessly linked to the first audio unit 15 via the wireless communication arrangement 30 for wirelessly transmitting audio data between the first and second audio units 15, 221.

It is worth mentioning that the display unit 21 may be pivotally and adjustably mounted on the entertainment module 22 so that the entertainment module 22 may be mounted on a underneath a supporting fixture (such as the ceiling of the user's house) while the display unit 21 is capable of flipping downwardly from the entertainment module 22 for displaying the multimedia data or the captured video image. Moreover, the display unit 21 may also be adjustably mounted on the entertainment module 22 for turning in an optimal viewing angle in order to provide the user of the present invention with an excellent viewing angle for inspection of the security area or enjoyment of the multimedia data.

The base station 20 may further comprise an audio phone jack 24 provided thereon for connecting with a telecommunication network so as to allow for iPod, XM or SITRIUS connection.

The security control module 23 comprises a control circuitry electrically connecting with the security arrangement 10 and the display unit 20 in such a manner that the display unit 20 normally plays the multimedia data in the entertainment display mode, and when the security arrangement 10 is triggered, perhaps by the pressing of the doorbell actuator 111, the video capturing device 12 is activated and the display unit 20 is automatically switched to the security display mode for displaying the capturing video image so as to allow the user to personally yet remotely monitor the security area in a safe venue.

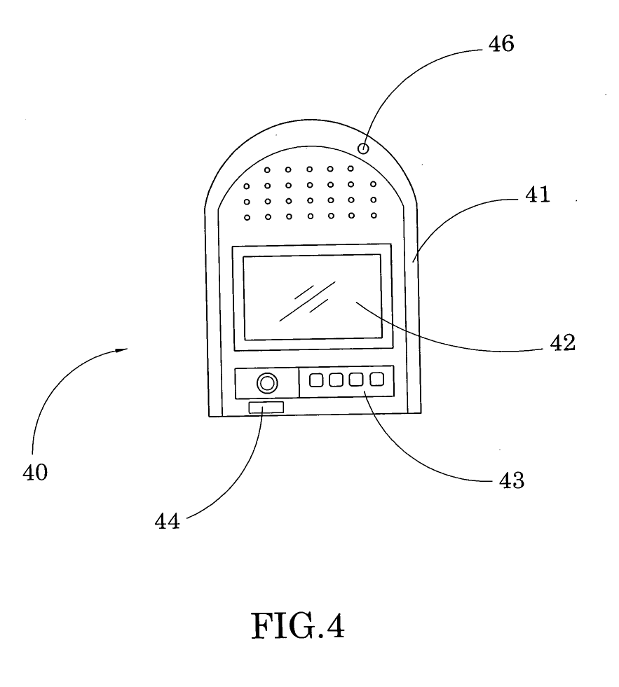

Referring to FIG. 4 of the drawings, the wireless entertainment and security system further comprises a remote control unit 40 wirelessly communicated with the security arrangement 10 and the base station 20 in such a manner that a user is able to control the security arrangement 10 and the base station 20, and monitor the video image captured from the security area by the remote control unit 40 so as to selectively switch the base station 20 to operate between the entertainment display mode and the security display mode.

According to the preferred embodiment of the present invention, the remote control unit 40 comprises a remote control casing 41, a remote display 42 provided on the remote control casing 41, and a control panel 43 provided on the remote control casing 41 for remotely controlling an operation of the base station 20 and the security arrangement 10. Specifically, the remote control unit 40 is communicated with the base station 20 in such a manner that the remote display 42 is arranged to be used as the display unit 21 of the base station 20 so that a user is able to watch the multimedia data played by the multimedia module 22 and the video image captured by the video capturing device 12 on the remote display 42 when the user is in a remote position from the base station 20.

Thus, the remote control unit 40 further comprises a remote wireless arrangement 44 wirelessly intercommunicating the remote control unit 40 with the base station 20 so that video and multimedia data received by the base station 20 is adapted to be displayed in the wireless remote control unit 40. In other words, the display unit 21 and the remote display 42 are simultaneously activated and switched between the entertainment mode and the security display mode. The remote wireless arrangement 44 comprises a wireless transmitter and a wireless receiver provided on the remote control casing 41 for transmitting and receiving wireless signal to and from the base station 20 so as to intercommunicate therewith.

Alternatively, the remote wireless arrangement 44 may directly and wirelessly communicate with the security arrangement 10 so that when the video capturing device 12 is activated, the remote display 42 is switched from the multimedia display mode to the security display mode. Thus, the remote control unit 40 further comprises a remote control module 45 for switching the remote display 42 operating between the multimedia display mode and the security display mode.

As a result, the remote control unit 40 further comprises a remote audio module comprising a microphone and a speaker provided on the remote control casing 41 for recording and delivering multimedia audio signal respectively. It is worth mentioning that the remote control unit 40 may further comprise a camera and a remote phone jack 46 provided on the remote control casing 41 for connecting with a telecommunication network so as to allow for iPod, XM or SITRIUS connection.

The wireless communication arrangement 30 comprises two wireless signal transceivers each of which comprises a wireless signal receiver 31 and a wireless signal transmitter 32 linked with the security arrangement 10 and the base station 20 for facilitating wireless signal transmissions between the security arrangement 10 and the base station 20. According to the preferred embodiment of the present invention, each of the wireless signal receivers 31 is embodied as a RF audio/video receiver while each of the wireless signal transmitters 32 is embodied as a RF audio/video transmitter, wherein wireless transmission between the wireless signal transmitters 32 and the wireless signal receiver 31 are accomplished through radio frequency transmission.

Thus, the two wireless RF transceivers is communicatively linked with the security arrangement 10 and the base station 20 respectively, wherein each of the wireless RF transceivers transmits the video data in form of radio frequency to each other so as to form a wireless network between the security arrangement 10 and the base station 20. Moreover, the two wireless RF transceivers are automatically tuned to match an optimum channel to form the wireless network for video transmission.

The wireless communication arrangement 30 further comprises a data encrypting module 33 linked to the wireless RF transceivers to encrypt the video data from the video capturing device 12 so as to ensure a security of the security arrangement 10. As a result, the video data is encrypted to ensure maximum security of the wireless entertainment and security system of the present invention.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wireless entertainment and security system, comprising:
at least one security arrangement which comprises a video activator defining a security area, and a video capturing device electrically linked to said video activator and arranged in such a manner that when said video activator activates said video capturing device, said video capturing device is arranged for capturing video within said security area and converting said video into a video data;
a base station which comprises a display unit, an entertainment module arranged for reading a multi-media data, and a security control module, wherein said display unit is linked to said entertainment module and said security control module for selectively switching between a default entertainment display mode for displaying said multi-media data and a security display mode for displaying said video data; and
a wireless communication arrangement wirelessly linking said security arrangement with said base station to wirelessly transmit said video data to said security control module such that when said video capturing device is activated, said security display mode is automatically switched on that said security control module starts to receive said video data to be displayed at said display unit.

2. The wireless entertainment and security system, as recited in claim 1, wherein said video activator comprises a doorbell actuator arranged when said doorbell actuator is pressed, said video capturing device is activated to capture a video image in said security area, wherein said security arrangement further comprises a doorbell module, which is adapted for outdoor utilizing propose, comprising a weatherproof doorbell housing receiving said video activator and said video capturing device therein.

3. The wireless entertainment and security system, as recited in claim 3, wherein said video capturing device comprises a video camera provided on said doorbell housing at a predetermined position for capturing color video images in the security area in real-time when said video actuator is activated, and a data converting circuitry linked with said video camera to convert said video image from said video camera into said video data.

4. The wireless entertainment and security system, as recited in claim 3, wherein said security arrangement further comprises a solar power system mounted on said doorbell module for collecting solar energy as a power supply to be used by said security arrangement, wherein aid solar power system comprises a plurality of solar energy collection panels mounted on said doorbell housing, an energy conversion module electrically connected with said solar energy collection panels, and a rechargeable battery electrically connected with said energy conversion module for storing said solar energy in form of electrical energy after conversion.

5. The wireless entertainment and security system, as recited in claim 3, further comprising a first audio unit communicatively provided at said security arrangement and a second audio unit which is communicatively provided at said base station and is wirelessly linked to said first audio unit via said wireless communication arrangement for wirelessly transmitting audio data between said first and second audio units.

6. The wireless entertainment and security system, as recited in claim 4, further comprising a first audio unit communicatively provided at said security arrangement and a second audio unit which is communicatively provided at said base station and is wirelessly linked to said first audio unit via said wireless communication arrangement for wirelessly transmitting audio data between said first and second audio units.

7. The wireless entertainment and security system, as recited in claim 4, wherein each of said first and second audio units comprises a stereo microphone for receiving sound signal as said audio data and a stereo speaker unit for delivering said sound signal.

8. The wireless entertainment and security system, as recited in claim 6, wherein each of said first and second audio units comprises a stereo microphone for receiving sound signal as said audio data and a stereo speaker unit for delivering said sound signal.

9. The wireless entertainment and security system, as recited in claim 7, wherein said display unit comprises a LCD display panel selectively displaying said multimedia data read from said entertainment module and said video image captured by said video capturing device.

10. The wireless entertainment and security system, as recited in claim 8, wherein said display unit comprises a LCD display panel selectively displaying said multimedia data read from said entertainment module and said video image captured by said video capturing device.

11. The wireless entertainment and security system, as recited in claim 1, wherein said wireless communication arrangement comprises two wireless RF transceivers communicatively linked with said security arrangement and said base station respectively, wherein each of said wireless RF transceivers transmits said video data in form of radio frequency to each other so as to form a wireless network between said security arrangement and said base station.

12. The wireless entertainment and security system, as recited in claim 3, wherein said wireless communication arrangement comprises two wireless RF transceivers communicatively linked with said security arrangement and said base station respectively, wherein each of said wireless RF transceivers transmits said video data in form of radio frequency to each other so as to form a wireless network between said security arrangement and said base station.

13. The wireless entertainment and security system, as recited in claim 10, wherein said wireless communication arrangement comprises two wireless RF transceivers communicatively linked with said security arrangement and said base station respectively, wherein each of said wireless RF transceivers transmits said video data in form of radio frequency to each other so as to form a wireless network between said security arrangement and said base station.

14. The wireless entertainment and security system, as recited in claim 11, wherein said two wireless RF transceivers are automatically tuned to match an optimum channel to form said wireless network for video transmission.

15. The wireless entertainment and security system, as recited in claim 12, wherein said two wireless RF transceivers are automatically tuned to match an optimum channel to form said wireless network for video transmission.

16. The wireless entertainment and security system, as recited in claim 13, wherein said two wireless RF transceivers are automatically tuned to match an optimum channel to form said wireless network for video transmission.

17. The wireless entertainment and security system, as recited in claim 11, wherein said wireless communication arrangement further comprises a data encrypting module linked to said wireless RF transceivers to encrypt said video data from said video capturing device so as to ensure a security of said security arrangement.

18. The wireless entertainment and security system, as recited in claim 13, wherein said wireless communication arrangement further comprises a data encrypting module linked to said wireless RF transceivers to encrypt said video data from said video capturing device so as to ensure a security of said security arrangement.

19. The wireless entertainment and security system, as recited in claim 16, wherein said wireless communication arrangement further comprises a data encrypting module linked to said wireless RF transceivers to encrypt said video data from said video capturing device so as to ensure a security of said security arrangement.

20. The wireless entertainment and security system, as recited in claim 1, further comprising a remote control unit wirelessly controlling said security arrangement and said base station to selectively switch said base station between said entertainment display mode and said security display mode.

21. The wireless entertainment and security system, as recited in claim 13, further comprising a remote control unit wirelessly controlling said security arrangement and said base station to selectively switch said base station between said entertainment display mode and said security display mode.

22. The wireless entertainment and security system, as recited in claim 19, further comprising a remote control unit wirelessly controlling said security arrangement and said base station to selectively switch said base station between said entertainment display mode and said security display mode.

23. The wireless entertainment and security system, as recited in claim 3, wherein said display unit is pivotally and adjustably mounted to said entertainment module in such a manner that said display unit is adapted to flip and adjust with respect to said entertainment module for selectively displaying said multimedia data and said captured video image at an optimal viewing angle.

24. The wireless entertainment and security system, as recited in claim 13, wherein said display unit is pivotally and adjustably mounted to said entertainment module in such a manner that said display unit is adapted to flip and adjust with respect to said entertainment module for selectively displaying said multimedia data and said captured video image at an optimal viewing angle.

25. The wireless entertainment and security system, as recited in claim 22, wherein said display unit is pivotally and adjustably mounted to said entertainment module in such a manner that said display unit is adapted to flip and adjust with respect to said entertainment module for selectively displaying said multimedia data and said captured video image at an optimal viewing angle.
